(19) United States
(12) Patent Application Publication
(10) Pub. No.: US 2022/0158357 A1
(43) Pub. Date: May 19, 2022

(54) ANTENNA APPARATUS

(71) Applicant: Samsung Electro-Mechanics Co., Ltd, Suwon-si (KR)

(72) Inventors: Woncheol LEE, Suwon-si (KR); Jeongki RYOO, Suwon-si (KR); Nam Ki KIM, Suwon-si (KR); Hyungho SEO, Suwon-si (KR)

(73) Assignee: Samsung Electro-Mechanics Co., Ltd, Suwon-si (KR)

(21) Appl. No.: 17/201,170

(22) Filed: Mar. 15, 2021

(30) Foreign Application Priority Data
Nov. 19, 2020 (KR) 10-2020-0155460

(51) Int. Cl. H01Q 21/06; H01Q 1/52; H01Q 1/24; H01Q 9/04

(52) U.S. Cl. CPC H01Q 21/065; H01Q 1/523; H01Q 1/526; H01Q 9/045; H01Q 1/243

(57) ABSTRACT

An antenna device is provided. The antenna device includes a first patch antenna pattern configured to transmit or receive a first radio frequency (RF) signal, and including a concave portion disposed in at least one side of the first patch antenna pattern; a first feed via configured to feed to the first patch antenna pattern; and an additional antenna pattern disposed separate from the first antenna patch, and coupled to the first patch antenna pattern, and disposed in a position corresponding to the concave portion.

### CROSS-REFERENCE TO RELATED APPLICATIONS

This application claims the benefit under 35 USC § 119(a) to Korean Patent Application No. 10-2020-0155460 filed in the Korean Intellectual Property Office on Nov. 19, 2020, the entire disclosure of which is incorporated herein by reference for all purposes.

### BACKGROUND

### 1. Field

The following description relates to an antenna device.

### 2. Description of Related Art

Data traffic associated with mobile communication systems is increasing rapidly every year. Active technology development is underway to support the rapidly increasing data in real-time in a wireless network. For example, applications that process content related to IoT (Internet of Things)-based data, augmented reality (AR), virtual reality (VR), live VR/AR combined with SNS, autonomous driving, sync view (real-time image transmission from the user's perspective using an ultra-small camera), and the like utilize communication (e.g., fifth-generation (5G) communication, mmWave communication, and the like) that supports the transmission and receipt of large amounts of data.

Thus, recently, millimeter wave (mmWave) communication including 5G communication has been actively implemented.

A radio frequency (RF) signal with a high frequency bandwidth (e.g., 24 GHz, 28 GHz, 36 GHz, 39 GHz, 60 GHz, and the like) is easily absorbed which leads to data loss during the transmission process, and thus the quality of communication may be deteriorated rapidly. Thus, an antenna that transmits high frequency bandwidth signals may need a different technical approach from the existing antenna technology, and special technological developments, such as an additional power amplifier that obtains antenna gain, and that integrates antenna and radio frequency integrated circuit (RFIC), secures effective isotropic radiated power (EIRP), and the like may be necessary.

The above information is presented as background information only to assist with an understanding of the present disclosure. No determination has been made, and no assertion is made, as to whether any of the above might be applicable as prior art with regard to the disclosure.

### SUMMARY

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

In a general aspect, an antenna device includes a first patch antenna pattern, configured to transmit and/or receive a first radio frequency (RF) signal, and comprising a concave portion disposed in at least one side of the first patch antenna pattern; a first feed via, configured to feed to the first patch antenna pattern; and an additional antenna pattern, disposed separate from the first antenna patch, and coupled to the first patch antenna pattern, and disposed in a position corresponding to the concave portion, wherein at least a portion of the additional antenna pattern is disposed inside the concave portion.

A winding feed pattern may be electrically connected to an upper end of the first feed via, and of which at least a part of the winding feed pattern has a winding shape.

The winding feed pattern may include an extension part that extends from an end of the winding feed pattern.

The antenna device may include a second patch antenna pattern, configured to transmit and/or receive a second RF signal; and a second feed via, configured to feed to the second patch antenna pattern.

The antenna device may include first shield vias that are configured to surround the second feed via.

The antenna device may further include second shield vias that are symmetrical to the first shield vias, wherein the first shield vias and the second shield vias are arranged horizontally symmetrical with each other with reference to a virtual first extension line that connects the first feed via and the second feed via, and the first shield vias and the second shield vias are arranged horizontally symmetrical with each other with reference to a virtual second extension line that is perpendicular to the first extension line.

The first feed via may include a plurality of first feed vias that are configured to transmit a plurality of first RF signals, each having a different phase, and the second feed via comprises a plurality of second feed vias that are configured to transmit a plurality of second RF signals, each having a different phase.

At least one side of the first patch antenna pattern may be slanted with reference to one side of a substrate where the antenna device is mounted in a planar view.

The antenna device may further include an inductive line that is disposed in at least one side of the first patch antenna pattern, and is configured to be connected to the first patch antenna pattern through a connection via.

The inductive line may overlap the concave portion in a vertical direction.

The antenna device may further include an expansion patch antenna pattern that is coupled to the first patch antenna pattern, separated from the first patch antenna pattern and the additional antenna pattern, and is disposed in at least one side of the first patch antenna pattern.

The antenna device may further include a winding feed pattern that is electrically connected to an upper end of the first feed via and of which a portion of the winding feed pattern has a winding shape, wherein the winding feed pattern overlaps at least a portion of the expansion patch antenna pattern in a vertical direction.

In a general aspect, as antenna array includes a first antenna device includes a first patch antenna pattern, configured to transmit and/or receive a first radio frequency (RF) signal, and comprising a concave portion disposed in at least one side of the first patch antenna pattern; a first feed via, configured to feed to the first patch antenna pattern; and an additional antenna pattern, coupled to the first patch antenna pattern, and disposed separate from the first patch antenna pattern; and a second antenna device, disposed separate from the first antenna device, wherein at least one side of the first patch antenna pattern is slanted with reference to one side of a substrate where the first antenna device and the second antenna device are mounted in a planar view.

The antenna array may include a plurality of shielding structures that are disposed between the first antenna device and the second antenna device.

The antenna array may further include a second patch antenna pattern, configured to transmit and/or receive a second RF signal; and a second feed via, configured to feed to the second patch antenna pattern.

The first feed via may include a plurality of first feed vias, configured to transmit a plurality of first RF signals, each having a different phase, and the second feed via may include a plurality of second feed vias, configured to transmit a plurality of second RF signals, each having a different phase.

In a general aspect, an electronic device includes an antenna device, including a first patch antenna pattern, configured to transmit and/or receive a first radio frequency (RF) signal; a first antenna pattern, disposed to face a concave portion formed on at least one side of the first patch antenna pattern; a first feed via, disposed separate from the first patch antenna pattern, and configured to provide a feeding path to the first patch antenna; a second patch antenna pattern configured to transmit and/or receive a second RF signal different from the first RF signal, and disposed to overlap the first antenna patch; and a second feed via, separated from the first feed via, and configured to feed the second patch antenna pattern.

The electronic device may further include a winding feed pattern configured to provide a feeding path to the first patch antenna pattern.

The electronic device may further include an inductive line, configured to face the concave portion.

The electronic device may further include a plurality of expansion patch antenna patterns, disposed on at least one side of the first patch antenna pattern.

Other features and aspects will be apparent from the following detailed description, the drawings, and the claims.

### BRIEF DESCRIPTION OF DRAWINGS

FIG. 1 is a perspective view of an example antenna device, in accordance with one or more embodiments.

FIG. 2 is a perspective view of an example antenna device, in accordance with one or more embodiments.

FIG. 3 is a perspective view of an example antenna device, in accordance with one or more embodiments.

FIG. 4 is a perspective view of an example antenna device, in accordance with one or more embodiments.

FIG. 5 is a top plan view of an example antenna device, in accordance with one or more embodiments.

FIG. 6 is a perspective view of an example antenna device, in accordance with one or more embodiments.

FIG. 7 is a top plan view of an example antenna device, in accordance with one or more embodiments.

FIG. 8 is a front view of an example antenna device, in accordance with one or more embodiments.

FIG. 9 is a top plan view of arrangement of a plurality of example antenna devices, in accordance with one or more embodiments.

FIG. 10 is a side view that schematically shows a structure of a lower side of an example antenna device, in accordance with one or more embodiments.

FIG. 11 is a schematic side view of a structure of a lower side of an example antenna device, in accordance with one or more embodiments.

FIG. 12 is a top plan view of an example antenna device arrangement in an example electronic device, in accordance with one or more embodiments.

FIG. 13 is a top plan view of an example antenna device arrangement in an example electronic device, in accordance with one or more embodiments.

FIG. 14 is a top plan view of an example antenna device arrangement in an example electronic device, in accordance with one or more embodiments.

FIG. 15A illustrates an electromagnetic field distribution of an example antenna device of which a plurality of shielding vias have a symmetric arrangement structure.

FIG. 15B illustrates an electromagnetic field distribution of an example antenna device of which a plurality of shielding vias have an asymmetric arrangement structure, in accordance with one or more embodiments.

Throughout the drawings and the detailed description, unless otherwise described or provided, the same drawing reference numerals will be understood to refer to the same elements, features, and structures. The drawings may not be to scale, and the relative size, proportions, and depiction of elements in the drawings may be exaggerated for clarity, illustration, and convenience.

### DETAILED DESCRIPTION

The following detailed description is provided to assist the reader in gaining a comprehensive understanding of the methods, apparatuses, and/or systems described herein. However, various changes, modifications, and equivalents of the methods, apparatuses, and/or systems described herein will be apparent after an understanding of the disclosure of this application. For example, the sequences of operations described herein are merely examples, and are not limited to those set forth herein, but may be changed as will be apparent after an understanding of the disclosure of this application, with the exception of operations necessarily occurring in a certain order. Also, descriptions of features that are known after an understanding of the disclosure of this application may be omitted for increased clarity and conciseness, noting that omissions of features and their descriptions are also not intended to be admissions of their general knowledge.

The features described herein may be embodied in different forms, and are not to be construed as being limited to the examples described herein. Rather, the examples described herein have been provided merely to illustrate some of the many possible ways of implementing the methods, apparatuses, and/or systems described herein that will be apparent after an understanding of the disclosure of this application.

The size and thickness of each configuration shown in the drawings are arbitrarily shown for better understanding and ease of description, but the examples are not limited thereto. In the drawings, the thickness of layers, films, panels, regions, etc., are exaggerated for clarity. The thicknesses of some layers and areas are exaggerated for convenience of explanation.

It will be understood that when an element such as a layer, film, region, or substrate is referred to as being “on” another element, it can be directly on the other element or intervening elements may also be present. In contrast, when an element is referred to as being “directly on” another element, there are no intervening elements present. The word “on” or “above” means disposed on or below the object portion, and does not necessarily mean disposed on the upper side of the object portion based on a gravitational direction.

Although terms such as “first,” “second,” and “third” may be used herein to describe various members, components, regions, layers, or sections, these members, components, regions, layers, or sections are not to be limited by these terms. Rather, these terms are only used to distinguish one member, component, region, layer, or section from another member, component, region, layer, or section. Thus, a first member, component, region, layer, or section referred to in examples described herein may also be referred to as a second member, component, region, layer, or section without departing from the teachings of the examples.

Throughout the specification, when an element, such as a layer, region, or substrate is described as being “on,” “connected to,” or “coupled to” another element, it may be directly “on,” “connected to,” or “coupled to” the other element, or there may be one or more other elements intervening therebetween. In contrast, when an element is described as being “directly on,” “directly connected to,” or “directly coupled to” another element, there can be no other elements intervening therebetween.

The terminology used herein is for describing various examples only, and is not to be used to limit the disclosure. The articles “a,” “an,” and “the” are intended to include the plural forms as well, unless the context clearly indicates otherwise. The terms “comprises,” “includes,” and “has” specify the presence of stated features, numbers, operations, members, elements, and/or combinations thereof, but do not preclude the presence or addition of one or more other features, numbers, operations, members, elements, and/or combinations thereof.

Unless otherwise defined, all terms, including technical and scientific terms, used herein have the same meaning as commonly understood by one of ordinary skill in the art to which this disclosure pertains and after an understanding of the disclosure of this application. Terms, such as those defined in commonly used dictionaries, are to be interpreted as having a meaning that is consistent with their meaning in the context of the relevant art and the disclosure of this application, and are not to be interpreted in an idealized or overly formal sense unless expressly so defined herein.

Example embodiments described herein provide an antenna that can be easily down-sized.

Throughout the description, when an element is referred to as being “above” another element, this includes not only the case where another element is “directly above”, but also the case where there is another element in the middle. On the contrary, when an element is referred to as being “below” another element, this includes not only the case where the other element is “directly below”, but also the case where there is another element in the middle.

Throughout the description, a pattern, a via, a plane, a line, and an electrical connection structure may include a metallic material (e.g., a conductive material such as copper (Cu), aluminum (Al), silver (Ag), tin (Sn), gold (Au), nickel (Ni), lead (Pb), titanium (Ti), or an alloy thereof), and may be formed according to a plating method such as chemical vapor deposition (CVD), physical vapor deposition (PVD), sputtering, a subtractive process, an additive process, a semi-additive process (SAP), a modified semi-additive process (MSAP), and the like, but this is not restrictive.

Throughout the description, a dielectric layer and/or an insulation layer may be implemented with a thermosetting resin such as FR4, a liquid crystal polymer (LCP), lower temperature co-fired ceramic (LTCC), an epoxy resin, and the like, a thermoplastic resin such as polyimide, or a resin formed by impregnating the thermosetting resin and the thermoplastic resin in core materials such as glass fiber (glass fiber, glass cloth, glass fabric) with inorganic filler, prepreg, Ajinomoto build-up film (ABF), FR-4, bismaleimide triazine (BT), a photo imageable dielectric (PID) resin, a typical copper clad laminate (CCL), or a class or ceramic-based insulation material.

Throughout the specification, an RF signal includes Wi-Fi (IEEE 802.11 family, etc.), WiMAX (IEEE 802.16 family, etc.), IEEE 802.20, LTE (long term evolution), Ev-DO, HSPA, HSDPA, HSUPA, EDGE, GSM, GPS, GPRS, CDMA, TDMA, DECT, Bluetooth, 3G, 4G, 5G, and any other wireless and wired protocols designated thereafter, but is not limited thereto.

Hereinafter, an example antenna device, in accordance with one or more embodiments, will be described in detail with reference to the accompanying drawings.

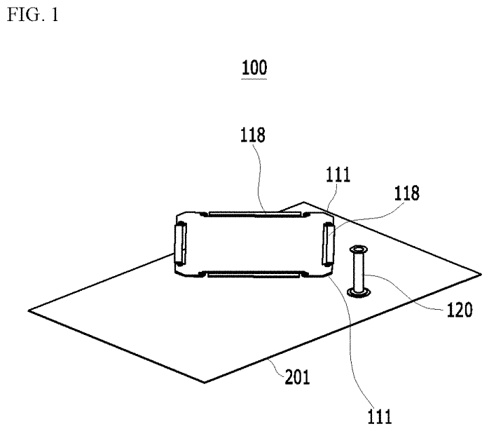

FIG. 1 is a perspective view of an example antenna device, in accordance with one or more embodiments.

Referring to FIG. 1, an antenna device 100 includes a first patch antenna pattern 111, a first feed via 120, and an additional or first antenna pattern 118. The antenna device 100 may further include a ground plane 201.

The first patch antenna pattern 111 may be disposed on the ground plane 201. The first patch antenna pattern 111 may have a first resonance frequency, and may remotely transmit or remotely receive an RF signal that is close to a first resonance frequency.

While remotely transmitting or receiving the RF signal, most of a surface current corresponding to the RF signal may flow through the top and bottom surfaces of the first patch antenna pattern 111. Such a surface current may form an electric field in a first horizontal direction that is the same as a direction of the surface current, or may form an electric field in a second horizontal direction that is perpendicular to the surface current direction. Most of the RF signal may be propagated through air or a dielectric layer in a direction (e.g., a z-axis direction) that is perpendicular to the first and second horizontal directions. Accordingly, the radiation pattern of the first patch antenna pattern 111 may be intensively formed in a normal direction (e.g., the z-axis direction) of the upper and lower surfaces of the first patch antenna pattern 111. In addition, as the radiation pattern concentration of the first patch antenna pattern 111 increases, the gain of the first patch antenna pattern 111 may be improved.

The ground plane 201 may support the radiation pattern concentration of the first patch antenna pattern 111 by reflecting the RF signal. Accordingly, the gain of the first patch antenna pattern 111 can be further improved, and the ground plane 201 may support formation of impedance corresponding to the first resonance frequency of the first patch antenna pattern 111. The ground plane 201 may improve the electromagnetic isolation between antenna patterns and an IC.

The surface current flowing in the first patch antenna pattern 111 may be formed based on a feeding path provided to the first patch antenna pattern 111. The feeding path may be connected to an integrated circuit (IC) from the first patch antenna pattern 111, and may be a transmission path of the RF signal. The IC may perform at least some of frequency conversion, amplification, filtering, phase control, and power generation, and may generate an RF signal to be transmitted.

The first feed via 120 may provide a feeding path to the first patch antenna pattern 111. The first feed via 120 penetrates the ground plane 201 and/or a dielectric layer. The first feed via 120 is separated from the first patch antenna pattern 111, and may not contact the first patch antenna pattern 111. Accordingly, constituent elements at the periphery of the first feed via 120 and the first patch antenna pattern 111 can be more freely designed, thereby providing additional impedance to the first patch antenna pattern 111. At least one additional resonance frequency that corresponds to the additional impedance may widen a pass bandwidth of the first patch antenna pattern 111. A width of the bandwidth may be determined based on appropriateness of a frequency difference between the at least one additional resonance frequency and the first resonance frequency, and the number of additional resonance frequencies close to the first resonance frequency among the at least one additional resonance frequency.

The higher the degree of design freedom of components in the vicinity of the first feed via 120 and the first patch antenna pattern 111, the appropriateness and/or number of the at least one additional resonance frequency can be improved more efficiently. Accordingly, the first feed via 120 provides a non-contact feeding path for the first patch antenna pattern 111, and thus the bandwidth of the first patch antenna pattern 111 can be improved more efficiently.

Further, the first feed via 120 can provide a contact-type feeding path for the first patch antenna pattern 111.

The additional antenna pattern 118 is separated from the first patch antenna pattern 111, while being coupled to the first patch antenna pattern 111. The additional antenna pattern 118 is disposed at a position facing a concave portion that is formed in at least one side of the first patch antenna pattern 111. The additional antenna pattern 118 is disposed corresponding to the concave portion, and at least a portion of the additional antenna pattern 118 may be disposed inside the concave portion. The concave portion of the first patch antenna pattern 111 can optimize an electrical length of the surface current flowing to the first patch antenna pattern 111. The additional antenna pattern 118 disposed at the position facing the first patch antenna pattern 111 can provide additional impedance, and accordingly, an additional resonance frequency can be provided and a bandwidth can be expanded.

When the first patch antenna pattern 111 is formed in the shape of a quadrangle, the concave portion may be provided in each of the four sides of the first patch antenna pattern 111. Additionally, in an example, four additional antenna patterns may be located at positions corresponding to the four concave portions, respectively. Accordingly, the extended bandwidth may be stably provided due to the first patch antenna pattern 111 and the additional antenna pattern 118, and a uniform gain may be provided.

The additional antenna pattern 118 is disposed on the ground plane 201. The additional antenna pattern 118 may be disposed in the same layer as the first patch antenna pattern 111. Additionally, the additional antenna pattern 118 may be disposed above or below the first patch antenna pattern 111.

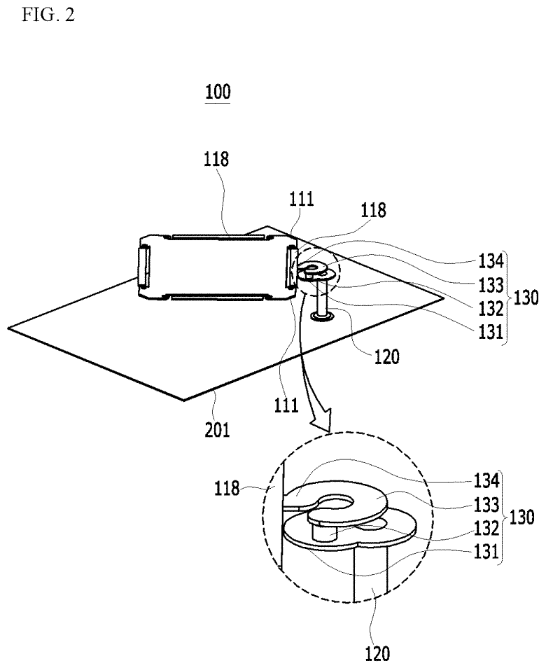

FIG. 2 is a perspective view of an example antenna device, in accordance with one or more embodiments.

Referring to FIG. 2, an antenna device 100 may include a first patch antenna pattern 111, a first feed via 120, an additional antenna pattern 118, and a winding feed pattern 130. The antenna device 100 may selectively include a ground plane 201. Among the configurations of the antenna device 100 of FIG. 2, the above-stated description of the antenna device 100 of FIG. 1 is applied to the configurations overlapping with the antenna device 100 of FIG. 1.

The winding feed pattern 130 may be electrically connected to an upper end of the first feed via 120, and may be separated from the first patch antenna pattern 111. The winding feed pattern 130 may be disposed in a space formed due to separation of the first feed via 120 and the first patch antenna pattern 111, and thus design freedom of the winding feed pattern 130 can be improved.

At least some of the winding feed pattern may have a winding form. For example, the winding feed pattern 130 may include at least one of a first winding feed pattern 131, a winding via 132, and a second winding feed pattern 133, and the second winding feed pattern 133 may include an extension part 134.

The winding feed pattern 130 provides a feeding path to the first patch antenna pattern 111 by electromagnetic coupling for the first patch antenna pattern 111. Since the winding feed pattern 130 can be used as a feeding path, a winding current corresponding to the FR signal transmitted through the winding feed pattern 130 can flow through the winding feed pattern 130. A direction of the winding current may rotate corresponding to a winding shape of the winding feed pattern 130. Accordingly, self-inductance of the winding feed pattern 130 may be boosted such that the winding feed pattern 130 may have relatively high inductance. The winding feed pattern 130 can provide the inductance to the first patch antenna pattern 111, and thus the first patch antenna pattern 111 may have a wider bandwidth based on an additional resonance frequency that corresponds to the inductance.

At least some of the winding feed pattern 130 may have a shape extending in a plurality of directions from one end of the winding shape. The winding feed pattern 130 may include an extension part 134. As the number of extension directions in the extension part 134 increases or the angle between the extension directions in the extension part 134 increases, energy corresponding to the RF signal in the winding feed pattern 130 may be more concentrated in the extension part 134.

Since the winding feed pattern 130 includes the extension part 134 where energy is concentrated, the first patch antenna pattern 111 may use the extension part 134 as a relay point for impedance matching of the feeding path. Accordingly, the extension part 134 can more improve impedance matching efficiency of the feeding path with respect to the first patch antenna pattern 111. Additionally, since electromagnetic coupling concentration for the first patch antenna pattern 111 of the winding feed pattern 130 can be increased in the antenna device 100, the gain of the first patch antenna pattern 111 can be more improved.

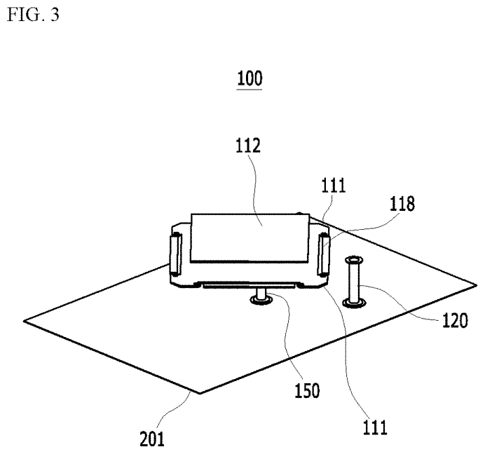

FIG. 3 is a perspective view of an example antenna device, in accordance with one or more embodiments.

Referring to FIG. 3, an antenna device 100 may include a first patch antenna pattern 111, a second patch antenna pattern 112, an additional antenna pattern 118, a first feed via 120, and a second feed via 150. The antenna device 100 may selectively include a ground plane 201. Among the configurations of the antenna device 100 of FIG. 3, the above-stated description of the antenna device 100 of FIG. 1 is applied to the configurations overlapping with the antenna device 100 of FIG. 1.

The second patch antenna pattern 112 may be disposed to be at least partially overlapped with the first patch antenna pattern 111 in a vertical direction (e.g., a z-axis direction) from an upper side of the first patch antenna pattern 111.

The second feed via 150 is separated from the first feed via 120, and penetrates through the first patch antenna pattern 111 and is coupled to the second patch antenna pattern 112. For example, the second patch antenna pattern 112 may be directly or indirectly fed from the second feed via 150. The second feed via 150 may provide a feeding patch for the second patch antenna pattern 112 to the second patch antenna pattern 112, and may be used as a transmission path of a second RF signal.

The second patch antenna pattern 112 may be formed to have a second resonance frequency that is different from a first resonance frequency, and the second RF signal may have a second frequency that is different from a first frequency of an RF signal that is remotely transmitted/received to/from the first patch antenna pattern 111. For example, when the second frequency is higher than the first frequency, the size of the second patch antenna pattern 112 may be smaller than the size of the first patch antenna pattern 111. The antenna device 100 may have a plurality of frequency bandwidths that are different according to design. Further, in terms of the second patch antenna pattern 112, the first patch antenna pattern 111 may be used as a ground plane for the second frequency.

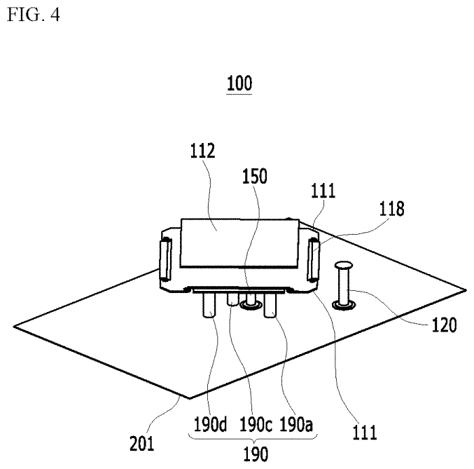

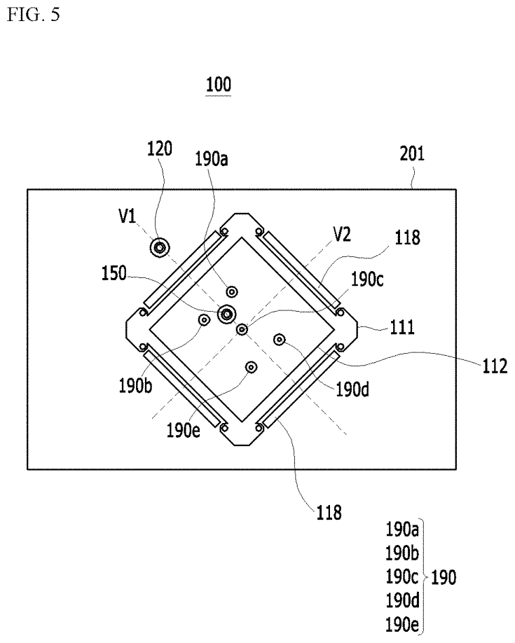

FIG. 4 is a perspective view of an example antenna device, in accordance with one or more embodiments, and FIG. 5 is a top plan view of an example antenna device, in accordance with one or more embodiments.

Referring to FIG. 4 and FIG. 5, an antenna device 100 may include a first patch antenna pattern 111, a second patch antenna pattern 112, an additional antenna pattern 118, a first feed via 120, a second feed via 150, and a plurality of shielding vias 190. The antenna device 100 may selectively include a ground plane 201. Among the configurations of the antenna device 100 of FIG. 4 and FIG. 5, the above-stated description of the antenna device 100 of FIG. 3 is applied to the configurations overlapping with the antenna device 100 of FIG. 3.

Referring to FIG. 5, the plurality of shielding vias 190 are located close to the second feed via 150. In an example, the plurality of shielding vias 190 may be arranged to surround the second feed via 150. The plurality of shielding vias 190 may be arranged to connect between the first patch antenna pattern 111 and the ground plane 201. The plurality of shielding vias 190 may shield the second feed via 150 from signals transmitted to, or received from, the first patch antenna pattern 111.

The second feed via 150 is disposed to penetrate the first patch antenna pattern 111, and thus may be affected by radiation of the first RF signal concentrated in the first patch antenna pattern 111, and the plurality of shielding vias 190 reduce such an influence, thereby reducing deterioration of the gain of each of the first and second patch antenna patterns 111 and 112.

A first RF signal radiated toward the second feed via 150 among the first RF signals radiated from the first patch antenna pattern 111 may be reflected by the plurality of shielding vias 190, and thus electromagnetic isolation between the first RF signal and the second RF signal can be improved and the gain of each of the first and second patch antenna patterns 111 and 112 can be improved.

The number and width of the plurality of shielding vias 190 are not particularly limited. When a gap between the plurality of shielding vias 190 is shorter than a specific length (e.g., a length dependent on the first wavelength of the first RF signal, or a length dependent on the second wavelength of the second RF signal), the first RF signal or second RF signal may not be able to substantially pass through spaces between the plurality of shielding vias 190. Accordingly, the degree of electromagnetic isolation between the first and second RF signals can be further improved.

The plurality of shielding vias 190 may be arranged symmetrical to each other. For example, four shielding vias 190a, 190b, 190d, and 190e may be arranged horizontally symmetrical to each other with reference to a virtual first extension line V1 that connects the first feed via 120 and the second feed via 150, and the four shielding vias 190a, 190b, 190d, and 190e are arranged horizontally symmetrical to each other with reference to a virtual second extension line V2 that is perpendicular to the virtual first extension line V1. On the contrary, among the plurality of shielding vias 190, only three shielding vias 190a, 190b, and 190c may be present, and when two shielding vias 190d and 190e are not provided, the three shielding vias 190a, 190b, and 190c may be arranged horizontally symmetrical to each other with reference to the virtual second extension line V2.

Compared to an asymmetrical alignment structure of a plurality of shielding vias, when the plurality of shielding vias 190 are symmetrical to each other, a peak gain is shifted toward a boresight in the radiation pattern such that a difference between the peak gain and a gain at the boresight may be reduced. Additionally, in the example of a symmetrical arrangement of a plurality of shielding vias, the amount of current induced in the antenna device 100 in the E-field distribution may be more uniform than in the asymmetric arrangement of a plurality of shielding vias, and the magnitude of a fringing field may be larger in the antenna device 100. Accordingly, a beam tilting phenomenon of the antenna device 100 can be alleviated, a gain at the boresight can be improved, and a uniform gain can be formed within a bandwidth.

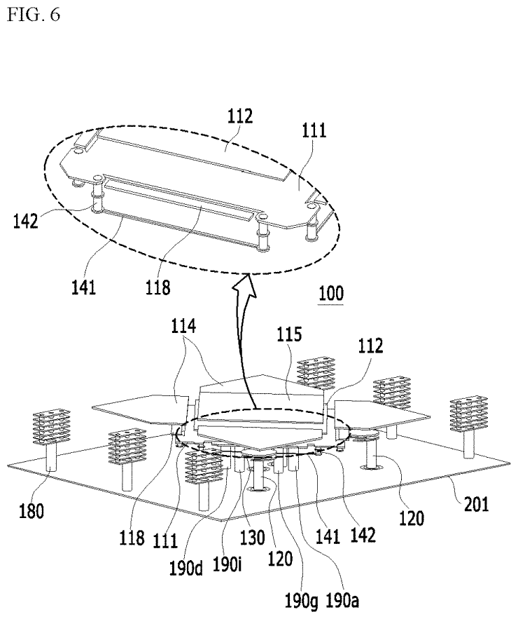

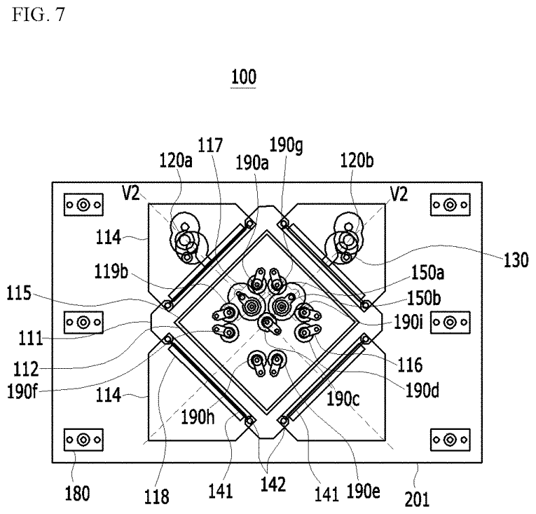

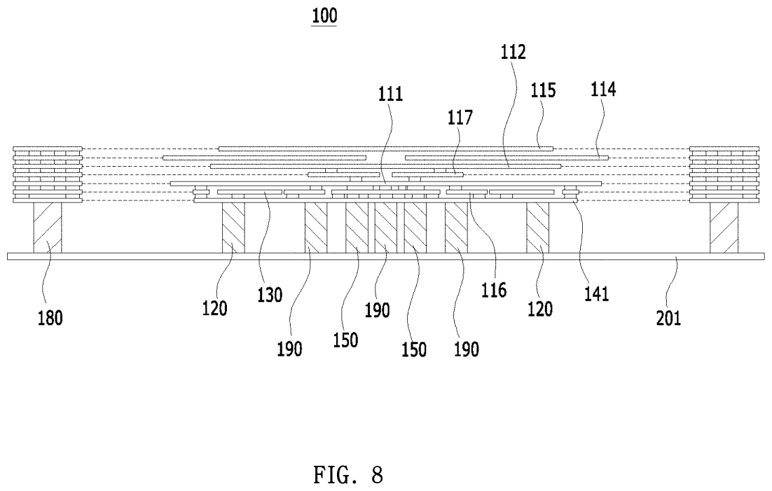

FIG. 6 is a perspective view of an example antenna device, in accordance with one or more embodiments, FIG. 7 is a top plan view of the example antenna device, in accordance with one or more embodiments, and FIG. 8 is a front view of the example antenna device, in accordance with one or more embodiments.

Referring to FIG. 6 to FIG. 8, an antenna device 100 may include a first patch antenna pattern 111, a second patch antenna pattern 112, a first feed via 120, a second feed via 150, and a plurality of shielding vias 190. The antenna device 100 may selectively include a ground plane 201. Among the configurations of the antenna device 100 of FIG. 6 to FIG. 8, the above-stated description of the antenna device 100 of FIG. 1 to FIG. 3 is applied to the configurations overlapping with the antenna device 100 of FIG. 1 to FIG. 3.

An inductive line 141 is disposed in at least one side of the first patch antenna pattern 111. The inductive line 141 may be extended to correspond to at least one side of the first patch antenna pattern 111. The inductive line 141 may be connected to the first patch antenna pattern 111 through a connection via 142. Since the inductive line 141 can provide a bypass path of a surface current flowing through the first patch antenna pattern 111, inductance that can be used for impedance matching of a feeding path for the first patch antenna pattern 111 can be provided to the first patch antenna pattern 111.

The first patch antenna pattern 111 may have a concave portion in a portion where the inductive line 141 is positioned. Accordingly, a ratio of vertical direction components in the electric field and/or magnetic field based on the surface current flowing through the inductive line 141 can be further increased. The vertical direction components may be used as impedance matching design elements of the feeding path for the first patch antenna pattern 111, and may be determined based on a length and a depth of the concave portion of the first patch antenna pattern 111. Accordingly, the first patch antenna pattern 111 can be fed more efficiently by having the concave portion that is concave in the portion where the inductive line 141 is positioned.

The concave portion of the first patch antenna pattern 111 may overlap the inductive line 141 in a vertical direction. Since the position of the inductive line 141 may affect the vertical direction components, the inductive line 141 can be designed more efficiently.

Additionally, electromagnetic coupling between the inductive line 141 and the winding feed pattern 130 can improve mutual inductance, and thus the impedance matching efficiency of the feeding path for the first patch antenna pattern 111 can be further improved.

Accordingly, the antenna device 100 can improve electromagnetic coupling concentration for the first patch antenna pattern 111 of the winding feed pattern 130, and thus the gain of the first patch antenna pattern 111 can be further improved.

The winding feed pattern 130 may provide a feeding path to the first patch antenna pattern 111 through the electromagnetic coupling for the first patch antenna pattern 111. As the concentration of the electromagnetic coupling increases, the energy loss of the electromagnetic coupling can be reduced, and the gain of the first patch antenna pattern 111 can be improved.

When the first patch antenna pattern 111 is formed in the shape of a quadrangle, four inductive lines 141 may be respectively located at positions corresponding to four sides of the first patch antenna pattern 111. Accordingly, the impedance matching efficiency of the feeding path for the first patch antenna pattern 111 can be stably provided, and a uniform gain can be provided.

The inductive line 141 can reduce the distribution of electric and/or magnetic fields due to fringing of the ground plane 201. The first patch antenna pattern 111, to which the inductive line 141 is connected, can support the concentration of the radiation pattern of the second patch antenna pattern 112 more efficiently, thereby further increasing the gain of the second patch antenna pattern 112, and the impedance formation corresponding to the second resonance frequency of the second patch antenna pattern 112 can be supported more efficiently.

A plurality of expansion patch antenna patterns 114 may be positioned on at least one side of the first patch antenna pattern 111, and may be coupled to the first patch antenna pattern 111. Additionally, the plurality of extended patch antenna patterns 114 may be spaced apart from the first patch antenna pattern 111 and the additional antenna pattern 118. Some of at least one of the plurality of expansion patch antenna patterns 114 may be disposed to be overlapped with the winding feed pattern 130 in the vertical direction (e.g., z-axis direction) from an upper side of the winding feed pattern 130. At least a portion of the second patch antenna pattern 112 may be disposed to be vertically overlapped with the first patch antenna pattern 111 in the vertical direction (e.g., z-axis direction) from an upper side of the first patch antenna pattern 111.

Since at least one of the plurality of expansion patch antenna patterns 114 can be electromagnetically coupled to the winding feed pattern 130, some of the energy corresponding to the RF signal may be provided to at least one of the plurality of expansion patch antenna patterns 114, and may be provided to the first patch antenna pattern 111 through the second patch antenna pattern 112. In this example, a feeding path of the winding feed pattern 130 can be further diversified, and thus the feeding efficiency of the winding feed pattern 130 can be further improved.

Accordingly, the antenna device 100 may improve electromagnetic coupling concentration for the first patch antenna pattern 111 and the second patch antenna pattern 112 of the winding feed pattern 130, and thus the gains of the first patch antenna pattern 111 and the second patch antenna pattern 112 can be further improved.

Additionally, impedance matching can be improved by the additional antenna pattern 118 together with the plurality of expansion patch antenna patterns 114. Accordingly, a high gain can be uniformly maintained within an operating frequency bandwidth of the antenna device 100.

When the antenna device 100 is implemented for 5G millimeter wave communication, the antenna device 100 may have a high and uniform gain for a signal having a quadruple bandwidth among 5G frequency bandwidths while having a small size. In an example, the quadruple band includes n257 (26.5-29.5 GHz), n258 (24.25-27.5 GHz), n260 (37-40 GHz), and n261 (27.5-28.35 GHz).

The antenna device 100 may include a first feed via 120 and a second feed via 150. The first feed via 120 may include a 1-1 feed via 120a and a 1-2 feed via 120b. The second feed via 150 may include a 2-1 feed via 150a and a 2-2 feed via 150b. Accordingly, the first feed via 120 and the second feed via 150 may transmit and receive a plurality of polarizations, each having a different phase.

Each of the 1-1 feed via 120a and the 1-2 feed via 120b allows a 1-1 RF signal and a 1-2 RF signal, which are polarized to each other, to pass. Each of the 2-1 feed via 150a and the 2-2 feed via 150b allows a 2-1 RF signal and a 2-2 RF signal, which are polarized to each other, to pass.

Each of the first patch antenna pattern 111 and the second patch antenna pattern 112 may transmit a plurality of RF signals, and the plurality of RF signals may be a plurality of carrier signals carrying different data. Accordingly, a data transmitting or receiving rate of each of the first patch antenna pattern 111 and the second patch antenna pattern 112 may be improved by 2 times according to the transmitting or receiving of the plurality of RF signals.

In an example, the 1-1 RF signal and the 1-2 RF signal have different phases (e.g.: a 90 degree or 180 degree phase difference) such that interference with each other can be reduced, and the 2-1 RF signal and the 2-2 RF signal have different phases (e.g.: a 90 degree or a 180 degree phase difference) such that an interference with each other can be reduced.

In an example, the 1-1 RF signal and the 2-1 RF signal respectively form an electric field and a magnetic field with respect to the x-axis direction and the y-axis direction that are perpendicular to the propagation direction (e.g., the z-axis direction), while being perpendicular to each other, thereby implementing polarization between RF signals. Surface currents corresponding to the 1-1 RF signal and the 2-1 RF signal and surface currents corresponding to the 1-2 RF signal and the 2-2 RF signal in the first patch antenna pattern 111 may flow to be perpendicular to each other. Here, the x-axis direction and the y-axis direction match directions indicated by sides that are perpendicular to each other in the first patch antenna pattern 112, and the z-axis direction matches a normal direction for the first patch antenna pattern 112.

The antenna device 100 may include a first feeding pattern 116. The first feeding pattern 116 may include a feeding path having a predetermined length, and may connect the first patch antenna pattern 111 and the first feed via 120 in the vertical direction. Accordingly, the first feeding pattern 116 can improve the impedance matching efficiency of the feeding path for the first patch antenna pattern 111, and the isolation between double polarizations can be improved, thereby reducing gain degradation, and a uniform gain can be provided.

The antenna device 100 may include a second feeding pattern 117. The second feeding pattern 117 may include a feeding path having a predetermined length, and may connect the second patch antenna pattern 112 and the second feed via 150 in the vertical direction. Accordingly, the second feeding pattern 117 can improve the impedance matching efficiency of the feeding path for the second patch antenna pattern 112, and the isolation between double polarizations can be improved, thereby reducing gain degradation, and a uniform gain can be provided.

The antenna device 100 may include a third patch antenna pattern 115. The third patch antenna pattern 115 is separated from the second patch antenna pattern 112 in the vertical direction, and overlaps at least some of the second patch antenna pattern 112 in a planar view. The third patch antenna pattern 115 is coupled with the second patch antenna pattern 112, and may improve the gain of the second patch antenna pattern 112 by increasing electromagnetic coupling concentration.

The plurality of shielding vias 190 may be arranged symmetrical to each other. In an example, eight shielding vias 190a, 190b, 190d, 190e, 190f, 190g, 190h, and 190i are arranged symmetrical to each other with reference to a virtual first extension line V1 that connects the 1-1 feed via 120a and the 2-1 feed via 150a, and the eight shielding vias 190a, 190b, 190d, 190e, 190f, 190g, 190h, and 190i are arranged symmetrical with each other with reference to a virtual second extension line V2 that connects the 1-2 feed via 120b and the 2-1 feed via 150b. On the contrary, when only five shielding vias 190a, 190b, 190c, 190g, and 190i are present and four shielding vias 190d, 190e, 190f, and 190h are not provided among the plurality of shielding vias 190, the five shielding vias 190a, 190b, 190c, 190g, and 190i are arranged horizontally asymmetrical to each other with reference to the virtual first extension line V1 or the virtual second extension line V2.

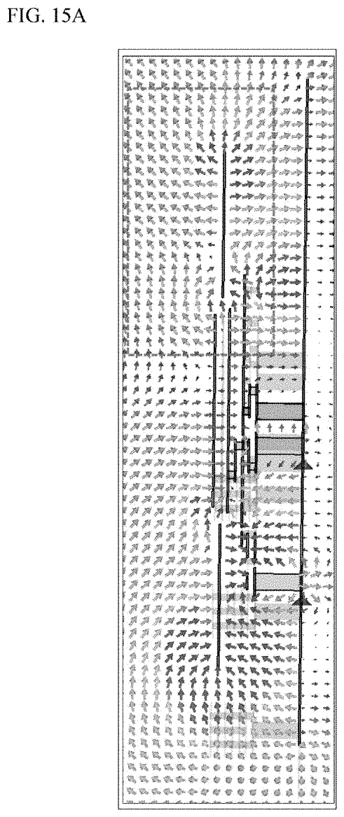

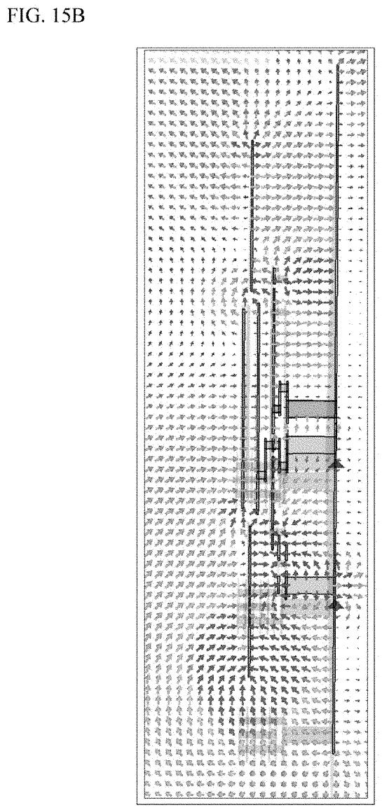

Compared to an asymmetrical alignment structure of a plurality of shielding vias, when the plurality of shielding vias 190 are symmetrical with each other, a peak gain is shifted toward a boresight in the radiation pattern such that a difference between the peak gain and a gain at the boresight may be reduced. Additionally, referring to FIG. 15A and FIG. 15B, in the example of the symmetric arrangement structure of the plurality of shielding vias, in an electromagnetic field distribution diagram, the amount of current induced in the antenna device 100 may be more uniform than the asymmetric arrangement structure of the plurality of shielding vias, and the magnitude of a fringing field may be larger in the antenna device 100. The arrows indicating the fringing field in FIG. 15A are thicker and longer than the arrows indicating the fringing field in FIG. 15B. FIG. 15A illustrates electromagnetic field distribution of an example antenna device of which a plurality of shielding vias have a symmetric arrangement structure, and FIG. 15B illustrates electromagnetic field distribution of an antenna device of which a plurality of shielding vias have an asymmetric arrangement structure. Accordingly, a beam tilting phenomenon of the antenna device 100 may be alleviated, a gain in a boresight may be improved, and a uniform gain may be formed within a bandwidth.

A plurality of shielding structures 180 may be disposed at the circumference of the antenna device 100, and may be electrically connected to the ground plane 201. Accordingly, the plurality of shielding structures 180 may prevent interference with other antenna devices positioned adjacent to each other, and the gain of the antenna device 100 may be increased.

When the antenna device 100 is implemented for 5G millimeter wave communication, a wideband of a patch antenna that is responsible for beam forming of a broadside may be implemented, and a module may be down-sized. Additionally, in the example of implementing a double polarized antenna, gain degradation may be reduced by improving the isolation between double polarized waves by using a feeding pattern, and a uniform gain can be provided. Additionally, the degree of isolation between the first resonance frequency and the second resonance frequency can be improved by applying a plurality of shielding vias 190, which are symmetrically arranged, to the first patch antenna pattern 111, and thus beam tilting is suppressed, thereby ensuring a high gain. Additionally, the gain of the second resonance frequency bandwidth may be additionally improved by applying the inductive line 141 to the first patch antenna pattern 111.

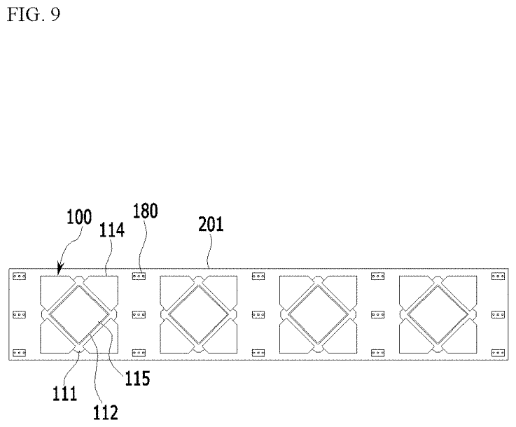

FIG. 9 is a top plan view of an arrangement of a plurality of example antenna devices, in accordance with one or more embodiments.

An antenna array may include a plurality of antenna devices 100. Each of the plurality of antenna devices 100 may be one of the above-described antenna devices of FIG. 1 to FIG. 8. At least one side of each of the plurality of antenna devices 100 may be slanted at a certain angle with respect to one side of a substrate on which the plurality of antenna devices 100 are mounted in a planar view. In an example, in the antenna device 100, at least one side of the first patch antenna pattern 111 or at least one side of the second patch antenna pattern 112 may be slanted in a planar view. Since the plurality of first patch antenna patterns 111 may be arranged so that they are not parallel with each other between the plurality of slanted antenna devices 100, the coupling between the plurality of first patch antenna patterns 111 may be weakened. Additionally, since the plurality of second patch antenna patterns 112 may be arranged so that they are not parallel with each other, the coupling between the plurality of second patch antenna patterns 112 may be weakened. Accordingly, a gain loss of the antenna device 100 may occur due to the coupling between the plurality of antenna devices 100, and the gain loss may be reduced between the plurality of slanted antenna devices 100. Additionally, since the first patch antenna pattern 111 may be slanted, compact design of the extended patch antenna pattern 114 is possible, and thus the size of the antenna device 100 may be reduced.

The plurality of shielding structures 180 may be disposed between the plurality of antenna devices 100 to block the plurality of antenna devices 100. The plurality of shielding structures 180 may prevent interference between the plurality of antenna devices 100, and thus the gain of the antenna array may be increased.

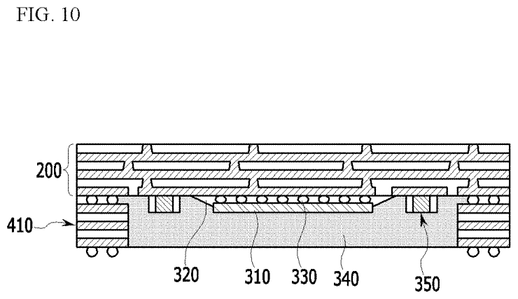

FIG. 10 is a side view that schematically illustrates a structure of a lower side of an example antenna device, in accordance with one or more embodiments.

Referring to FIG. 10, an example antenna device, in accordance with one or more embodiments, may include at least a part of a connection member 200, an IC 310, an adhesive member 320, an electrical connection structure 330, an encapsulation member 340, a manual part or passive component 350, and a core member 410.

The connection member 200 may have a structure in which a plurality of metal layers having a pre-designed pattern such as a printed circuit board (PCB), and a plurality of insulation layers are stacked.

The IC 310 may be disposed in a lower side of the connection member 200. The IC 310 may be connected to a wire of the connection member 200, and thus may transmit or receive an RF signal, and may receive a ground by being connected to a ground plane of the connection member 200. In an example, the IC 310 may generate a converted signal by performing at least some of frequency conversion, amplification, filtering, phase control, and power generation.

The adhesive member 320 may bond the IC 310 and the connection member 200 to each other.

The electrical connection structure 330 may connect the IC 310 and the connection member 200. In an example, the electrical connection structure 330 may have structures such as solder balls, pins, lands, and pads. The electrical connection structure 330 may have a lower melting point than the wiring of the connection member 200 and the ground plane, and thus the IC 310 and the connection member 200 can be connected through a predetermined process using such a lower melting point.

The encapsulation member 340 may encapsulate at least a part of the IC 310, and may improve heat dissipation performance and impact protection performance of the IC 310. In an example, the encapsulation member 340 may be implemented as a photoimageable encapsulant (PIE), an Ajinomoto build-up film (ABF), an epoxy molding compound (EMC), and the like.

The passive component 350 may be disposed on the bottom surface of the connection member 200, and may be connected to the wire of the connection member 200 and/or a ground plane. In an example, the passive component 350 may include at least one of a capacitor (e.g., a multi-layer ceramic capacitor (MLCC)), an inductor, and a chip resistor, but is not limited thereto.

In an example, the core member 410 may be disposed in a lower side of the connection member 200, and may be connected to the connection member 200 so as to receive an intermediate frequency (IF) signal or a baseband signal from an external source, and transmit the received signal to the IC 310, or to receive an IF signal or a baseband signal from the IC 310 and transmit the received signal to an external source. Here, a frequency (e.g., 24 GHz, 28 GHz, 36 GHz, 39 GHz, or 60 GHz) of the RF signal may be higher than a frequency (e.g., 2 GHz, 5 GHz, 10 GHz, and the like) of the IF signal.

In an example, the core member 410 may transmit an IF signal or a baseband signal to the IC 310, or receive an IF signal from the IC 310 through a wire that can be included in the IC ground plane of the connection member 200. Since the ground plane of the connection member 200 is disposed between the IC ground plane and the wire, the IF signal or baseband signal and the RF signal can be electrically separated from each other in the antenna device.

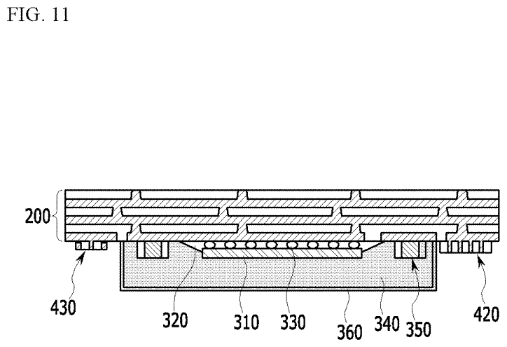

FIG. 11 is a schematic side view of a structure of a lower side of an example antenna device, in accordance with one or more embodiments.

Referring to FIG. 11, an example antenna device, in accordance with one or more embodiments, may include at least one of a shield member 360, a connector 420, and a chip antenna 430.

The shield member 360 may be disposed in a lower side of the connection member 200 to confine the IC 310 and the encapsulation member 340 along with the connection member 200. In an example, the shield member 360 may be disposed for conformal shielding of all of the IC 310, the passive component 350, and the encapsulation member 340, or compartmental shielding of each of the IC 310, the passive component 350, and the encapsulation member 340. In an example, the shield member 360 may have a shape of a hexahedron with one open side, and may have a hexahedral receiving space for combination with the connection member 200. The shield member 360 may have a short skin depth because it may be implemented with a material with high conductivity, such as copper, and may be connected to a ground plane of the connection member 200. Therefore, the shield member 360 can reduce electromagnetic noise that the IC 310 and the manual part 350 may receive. However, the encapsulation member 340 may be omitted depending on the various implementations.

The connector 420 may have a connection structure of a cable (e.g., a coaxial cable, a flexible PCB, and the like), may be connected to the IC ground plane of the connection member 200, and may play a similar role to that of a sub-board. The connector 420 may receive an IF signal, a baseband signal, and/or power from a cable, or may provide an IF signal and/or a baseband signal through a cable.

The chip antenna 430 may transmit or receive an RF signal in support of the example antenna device. In an example, the chip antenna 430 may include a dielectric block having a larger dielectric constant than an insulation layer, and a plurality of electrodes disposed at opposite sides of the dielectric block. One of the plurality of electrodes may be connected to a wire of the connection member 200, and the other may be connected to the ground plane of the connection member 200.

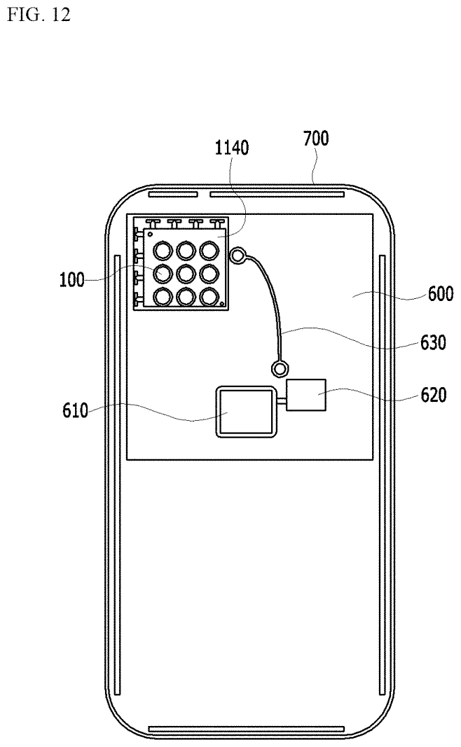

FIG. 12 is a top plan view that illustrates an example antenna device arrangement in an example electronic device, in accordance with one or more embodiments.

Referring to FIG. 12, example antenna devices 100 may be arranged adjacent to side boundaries of an example electronic device 700 on a set substrate 600 of the electronic device 700. The antenna device 100 may be one of the above-described antenna devices of FIG. 1 to FIG. 11.

The electronic device 700 may be, as non-limiting examples, a smart phone, a personal digital assistant, a digital video camera, a digital still camera, a network system, a computer, a monitor, a tablet, a laptop, a netbook, a television, a video game, a smart watch, an automotive part, and the like, but this is not restrictive.

A communication module 610 and a baseband circuit 620 may be further disposed on the set substrate 600. The antenna device 100 may be connected to the communication module 610 and/or the baseband circuit 620 through a coaxial cable 630.

The communication module 610 may include a memory chip such as a volatile memory (e.g., DRAM), a non-volatile memory (e.g., ROM), and a flash memory to perform digital signal processing; an application processor chip such as a central processor (e.g., CPU), a graphics processor (e.g., GPU), a digital signal processor, an encryption processor, a microprocessor, and a micro controller; and a logic chip such as an analog-digital converter and an application-specific IC (ASIC).

The baseband circuit 620 may generate a base signal by performing analog-digital conversion, amplification of an analog signal, filtering, and frequency conversion. The base signal input/output from the baseband circuit 620 may be transmitted to the antenna device through a cable.

In an example, the base signal may be transmitted to the IC through an electrical connection structures, core vias, and wiring. The IC can convert the base signal into a millimeter wave (mmWave) band RF signal.

A dielectric layer 1140 may be filled in a region in which patterns, vias, planes, lines, and electrical connection structures are not disposed in the antenna device according to the example.

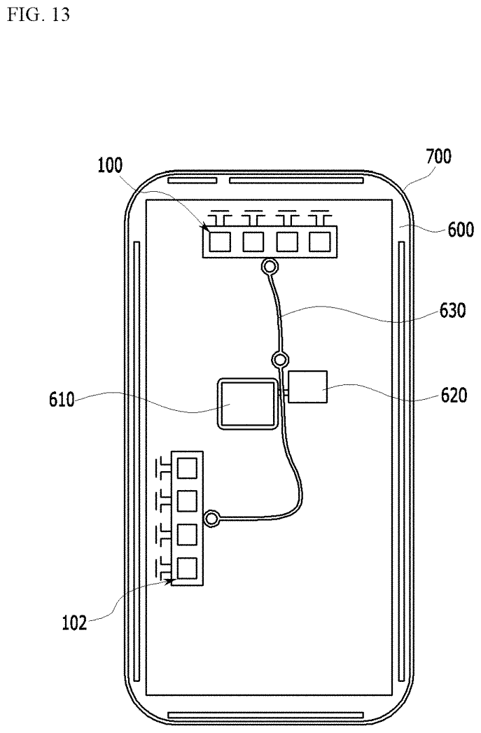

FIG. 13 is a top plan view that illustrates an example antenna device arrangement in an electronic device, in accordance with one or more embodiments.

Referring to FIG. 13, example antenna devices 100 may be disposed, as an example, adjacent to the center of each side of a polygonal electronic device 700 on a set substrate 600 of an electronic device 700, and a communication module 610 and a baseband circuit 620 may be further disposed on the set substrate 600. The antenna device 100 may be connected to the communication module 610 and/or the baseband circuit 620 through a coaxial cable 630. The antenna device 100 may be one of the above-described antenna devices of FIG. 1 to FIG. 11.

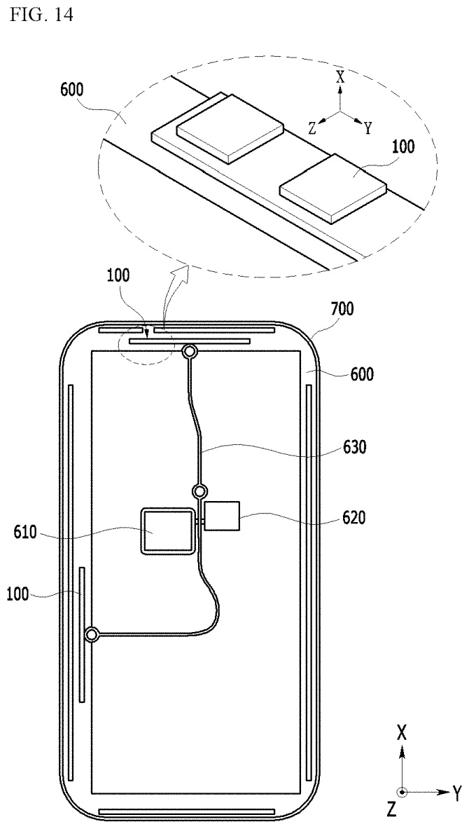

FIG. 14 is a top plan view that illustrates an example antenna device arrangement in an example electronic device, in accordance with one or more embodiments.

Referring to FIG. 14, antenna devices 100 may be disposed vertically on a side of a polygonal electronic device 700 on a set substrate 600 of an electronic device 700. For example, a boresight direction of an antenna device 100 disposed in an upper side of the electronic device 700 may be an X-axis direction, and a boresight direction of an antenna device 100 disposed on the left side of the electronic device 700 may be a Y-axis direction that becomes away from the electronic device 700. A communication module 610 and a baseband circuit 620 may be further disposed on the set substrate 600. The antenna device may be connected to the communication module 610 and/or the baseband circuit 620 through a coaxial cable 630. The antenna device 100 may be one of the above-described antenna devices of FIG. 1 to FIG. 11.

While this disclosure includes specific examples, it will be apparent after an understanding of the disclosure of this application that various changes in form and details may be made in these examples without departing from the spirit and scope of the claims and their equivalents. The examples described herein are to be considered in a descriptive sense only, and not for purposes of limitation. Descriptions of features or aspects in each example are to be considered as being applicable to similar features or aspects in other examples. Suitable results may be achieved if the described techniques are performed in a different order, and/or if components in a described system, architecture, device, or circuit are combined in a different manner, and/or replaced or supplemented by other components or their equivalents. Therefore, the scope of the disclosure is defined not by the detailed description, but by the claims and their equivalents, and all variations within the scope of the claims and their equivalents are to be construed as being included in the disclosure.

What is claimed is:

1. An antenna device comprising:
a first patch antenna pattern, configured to transmit and/or receive a first radio frequency (RF) signal, and comprising a concave portion disposed in at least one side of the first patch antenna pattern;
a first feed via, configured to feed to the first patch antenna pattern; and
an additional antenna pattern, disposed separate from the first antenna patch, and coupled to the first patch antenna pattern, and disposed in a position corresponding to the concave portion,
wherein at least a portion of the additional antenna pattern is disposed inside the concave portion.

2. The antenna device of claim 1, further comprising a winding feed pattern electrically connected to an upper end of the first feed via, and of which at least a part of the winding feed pattern has a winding shape.

3. The antenna device of claim 2, wherein the winding feed pattern comprises an extension part that extends from an end of the winding feed pattern.

4. The antenna device of claim 1, further comprising:
a second patch antenna pattern, configured to transmit and/or receive a second RF signal; and
a second feed via, configured to feed to the second patch antenna pattern.

5. The antenna device of claim 4, further comprising first shield vias that are configured to surround the second feed via.

6. The antenna device of claim 5, further comprising second shield vias that are symmetrical to the first shield vias,
wherein the first shield vias and the second shield vias are arranged horizontally symmetrical with each other with reference to a virtual first extension line that connects the first feed via and the second feed via, and the first shield vias and the second shield vias are arranged horizontally symmetrical with each other with reference to a virtual second extension line that is perpendicular to the first extension line.

7. The antenna device of claim 4, wherein:
the first feed via comprises a plurality of first feed vias that are configured to transmit a plurality of first RF signals, each having a different phase, and
the second feed via comprises a plurality of second feed vias that are configured to transmit a plurality of second RF signals, each having a different phase.

8. The antenna device of claim 1, wherein at least one side of the first patch antenna pattern is slanted with reference to one side of a substrate where the antenna device is mounted in a planar view.

9. The antenna device of claim 1, further comprising an inductive line that is disposed in at least one side of the first patch antenna pattern, and is configured to be connected to the first patch antenna pattern through a connection via.

10. The antenna device of claim 9, wherein the inductive line overlaps the concave portion in a vertical direction.

11. The antenna device of claim 1, further comprising an expansion patch antenna pattern that is coupled to the first patch antenna pattern, separated from the first patch antenna pattern and the additional antenna pattern, and is disposed in at least one side of the first patch antenna pattern.

12. The antenna device of claim 11, further comprising a winding feed pattern that is electrically connected to an upper end of the first feed via and of which a portion of the winding feed pattern has a winding shape,
wherein the winding feed pattern overlaps at least a portion of the expansion patch antenna pattern in a vertical direction.

13. An antenna array comprising:
a first antenna device comprising:
a first patch antenna pattern, configured to transmit and/or receive a first radio frequency (RF) signal, and comprising a concave portion disposed in at least one side of the first patch antenna pattern;
a first feed via, configured to feed to the first patch antenna pattern; and
an additional antenna pattern, coupled to the first patch antenna pattern, and disposed separate from the first patch antenna pattern; and
a second antenna device, disposed separate from the first antenna device,
wherein at least one side of the first patch antenna pattern is slanted with reference to one side of a substrate where the first antenna device and the second antenna device are mounted in a planar view.

14. The antenna array of claim 13, further comprising a plurality of shielding structures that are disposed between the first antenna device and the second antenna device.

15. The antenna array of claim 13, further comprising:
a second patch antenna pattern, configured to transmit and/or receive a second RF signal; and
a second feed via, configured to feed to the second patch antenna pattern.

16. The antenna array of claim 15, wherein:
the first feed via comprises a plurality of first feed vias, configured to transmit a plurality of first RF signals, each having a different phase, and
the second feed via comprises a plurality of second feed vias, configured to transmit a plurality of second RF signals, each having a different phase.

17. An electronic device, comprising:
an antenna device, comprising:
a first patch antenna pattern, configured to transmit and/or receive a first radio frequency (RF) signal;
a first antenna pattern, disposed to face a concave portion formed on at least one side of the first patch antenna pattern;
a first feed via, disposed separate from the first patch antenna pattern, and configured to provide a feeding path to the first patch antenna;
a second patch antenna pattern configured to transmit and/or receive a second RF signal different from the first RF signal, and disposed to overlap the first antenna patch; and
a second feed via, separated from the first feed via, and configured to feed the second patch antenna pattern.

18. The electronic device of claim 17, further comprising a winding feed pattern configured to provide a feeding path to the first patch antenna pattern.

19. The electronic device of claim 17, further comprising an inductive line, configured to face the concave portion.

20. The electronic device of claim 17, further comprising a plurality of expansion patch antenna patterns, disposed on at least one side of the first patch antenna pattern.
